(19) United States
(12) Patent Application Publication
(10) Pub. No.: US 2006/0233920 A1
(43) Pub. Date: Oct. 19, 2006

(54) Stringing popcorn to make a garland

(76) Inventor: Stephen D. Johnson, Sheridan, IL (US)

Correspondence Address: REINHART BOERNER VAN DEUREN P.C., 483 NORTH MULFORD ROAD, SUITE 7, ROCKFORD, IL, 61107, US

(21) Appl. No.: 11/401,169

(22) Filed: Apr. 10, 2006

Related U.S. Application Data
(60) Provisional application No. 60/672,441, filed on Apr. 18, 2005.

(51) Int. Cl. A23G 1/00

(52) U.S. Cl. 426/104

(57) ABSTRACT

A method of making a garland suitable for retail sale using popped popcorn is provided. The method comprising the steps of coating the popped popcorn, stringing the coated popped popcorn together, and packaging the garland for retail sale. As such, the garland suitable for retail sale is made. A garland is also provided. The garland comprises pieces of wax-coated popped popcorn and a string. Each of the pieces of the wax-coated popped popcorn includes an aperture. The string passes through the apertures in each of the pieces of the wax-coated popped popcorn.

### CROSS-REFERENCE TO RELATED PATENT APPLICATIONS

This patent application claims the benefit of U.S. Provisional Patent Application No. 60/672,441, filed Apr. 18, 2005, the teachings and disclosure of which are hereby incorporated in their entireties by reference thereto.

### FIELD OF THE INVENTION

This invention pertains to the field of popped popcorn and, in particular, to pieces of popped popcorn strung together to form a garland.

### BACKGROUND OF THE INVENTION

One of the longest running pastimes of the holiday seasons is that of stringing popped popcorn together to form holiday themed garlands. Often entire families will gather to undertake the task of making the popped popcorn, forming a garland with the pieces, and then hanging the garland on, for example, a Christmas tree or around the house for decoration during the holidays.

Unfortunately, the process of constructing the garlands is somewhat time consuming. After making several batches of the popped popcorn, each of the individual pieces of popped corn must be placed upon a string or wire. In many cases, this is accomplished using a threaded needle. For a sufficiently long length of garland to be constructed, a great deal of patience and time is required.

The process of making garlands is made even more time consuming and difficult due to the weak nature of the popped popcorn. As anyone who has made or attempted to make a garland knows, the pieces of popped popcorn often crumble and break apart when handled. This is especially true when a needle or other device is used to puncture the pieces of popped popcorn so that they are able to be strung together.

As a result of the above-mentioned difficulties, individuals and families often become frustrated and forego trying to make suitable garlands. This is despite a strong desire to adorn a Christmas tree or household with these aesthetically pleasing, holiday decorations. Therefore, there exists a need in the art for a more durable garland and a method of making the same. The invention described herein provides such a garland and method. These and other advantages of the invention, as well as additional inventive features, will be apparent from the description of the invention provided herein.

### BRIEF SUMMARY OF THE INVENTION

The invention provides a method for producing mass quantities of popped popcorn garlands. As will be more fully explained below in detail, the method entails providing a specific coating over the popped popcorn to strengthen and increasing the life of the garland. In addition, the coating produces a much larger piece of popped popcorn. In one embodiment, the coating is a wax. The wax and/or the popped popcorn may be enhanced with color, glitter, a scent, or a variety of other highlighting effects to augment the one or more characteristics of the decoration.

The process of manufacturing the garlands is performed using a sleeve having a lengthwise opening. The coated popped popcorn is inserted into the sleeve through the lengthwise opening such that the pieces of coated popped popcorn are organized and securely held in a linear arrangement. Thereafter, an elongate member such as a rotating or non-rotating wire or drill bit is advanced through the coated popped popcorn. As such, the elongate member individually and sequentially pierces each of the pieces of coated popped popcorn and forms apertures therethrough. Using these apertures, the coated popped popcorn is strung together to form the garland. The process is automated at various stages and to varying degrees depending on the number of garlands to be manufactured.

In an alternative embodiment, a string or wire is pressed into the coated popped popcorn in lieu of piercing each piece of the coated popped popcorn with the elongate member. Thereafter, an additional coating is formed on the coated popped popcorn. Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flow diagram illustrating a method of making a garland suitable for retail sale in accordance with the teachings of the present invention;

FIG. 2 is a perspective view of a representative piece of popped popcorn to be enhanced using the method of FIG. 1;

FIG. 3 is a perspective view of the piece of popped popcorn of FIG. 2 suspended over a container containing a coating substance;

FIG. 4 is a perspective view of a piece of coated popped popcorn formed by coating the popped popcorn of FIG. 1 in the coating substance held in the container of FIG. 3;

FIG. 5 is a perspective view of several pieces of the coated popped popcorn of FIG. 4 secured in a linear arrangement within a sleeve and ready to be punctured by a drill;

FIG. 6 is a perspective view of a piece of coated popped popcorn revealing an aperture after having been extracted from the sleeve of FIG. 5;

FIG. 7 is a perspective view of a garland formed by stringing together several of the pieces of coated popped popcorn of FIG. 6 using the apertures; and

FIG. 8 is a perspective view of the garland of FIG. 7 disposed in a retail package for sale to a consumer in a retail setting.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

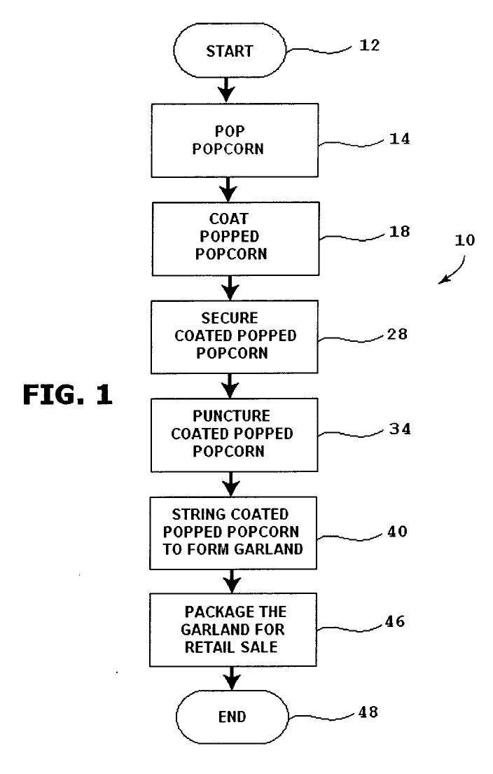

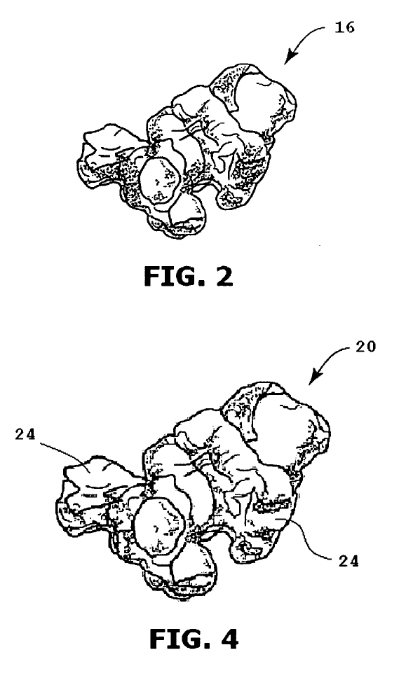

Referring to FIG. 1, a method 10 of making a garland suitable for retail sale using popped popcorn is illustrated. To start 12, the method 10 begins with popping 14 popcorn. In this regard, a variety of different types of popcorn may be selected such as, for example, white butterfly or mushroom, small and large yellow butterfly or mushroom, and other hybrid seeds or kernels. Other kernel color of specialty popcorn may also be used such as blue, red, black, or brown. Any of the types of popcorn kernels are employable in one embodiment of the method 10 outlined in FIG. 1. A representative piece of popped popcorn 16 is illustrated in FIG. 2.

The next step in the method of FIG. 1 is coating 18 the popped popcorn. For the purposes of illustration, the single piece of popped popcorn 16 shown in FIG. 2 will be discussed with regard to the coating step. However, those skilled in the art will recognize that any number of pieces of the popped popcorn 16 are simultaneously and/or successively coated depending on the degree of automation employed in the coating process.

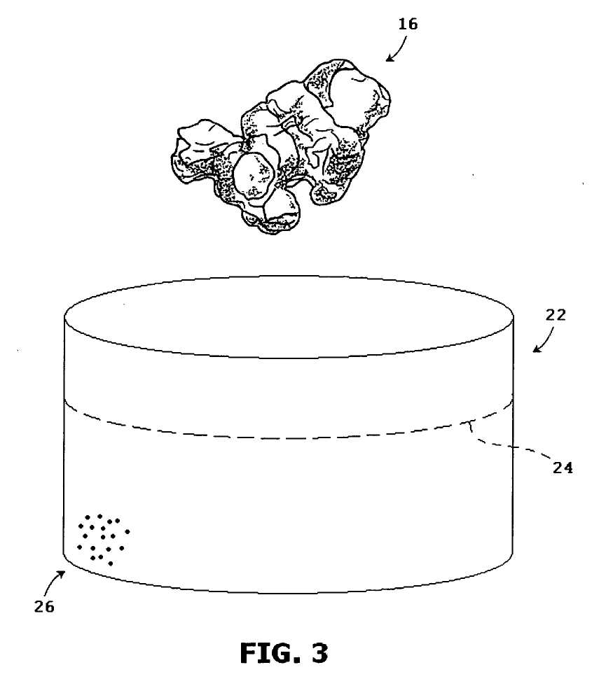

In one embodiment, as illustrated in FIG. 3, the popped popcorn 16 is coated by dipping the piece of popped popcorn into a container 22 of coating material 24 such as, for example, melted wax. When the wax cools and hardens, a piece of coated popped popcorn 20 is formed as illustrated in FIG. 4. A variety of different waxes are suitable for coating the popped popcorn 16 to produce the coated popped popcorn 20 such as, for example, a paraffin wax. In one embodiment, the popped popcorn 16 is dipped into the warm or hot wax, permitted to cool, and then re-dipped to add a second or subsequently layer of wax coating and form a larger, stronger piece of coated popped popcorn 20. In addition to dipping, other coating methods such as spraying, tumbling, and the like are used to coat the popped popcorn 16 with the coating material 24.

As visually apparent upon viewing FIGS. 2 and 4, the piece of coated popped popcorn 20 is noticeably larger than the piece of popped popcorn 16 which has not been coated. Because the coating substance 24 (e.g., the wax) increases the overall size and appearance of the popped popcorn 16, any type or brand of popcorn kernels are adequately employed to form the coated popped popcorn 20.

In addition to the size, the strength and durability of the coated popped popcorn 20 is far superior to the natural and/or unaltered popped popcorn 16. Therefore, the coated popped popcorn 20 of FIG. 4 is resistant to the crumbling and breaking all too often experienced by the uncoated popped popcorn 16 of FIG. 2. As will more fully explained and apparent below, this increase in strength and durability is important in maintaining a high-quality product with regard to the method 10 of making a garland.

In one embodiment, the coating material 24 placed upon the pieces of popped popcorn 16 is a substance other than wax such as, for example, glue, plastic, and the like. Such materials enhance the strength of the coated popped popcorn 20. Like the wax, these substances and/or materials are administered to the popped popcorn 16 using one of a variety of suitable application or coating techniques (e.g., dipping, spraying, etc.).

To ensure freshness and resist decomposition of the popped popcorn 16, in one embodiment one or more preservatives are sprayed on the popped popcorn 16 and/or added to the coating material 24 to keep the coated popped popcorn 20 fresh and strong for an extended period of time. Common preservatives well known in the food industry are suitable for this undertaking.

In one embodiment, the coating substance 24 includes a colored dye, paint, or other coloring substance. As a result, the pieces of coated popped popcorn 20 exhibit a variety of different colors corresponding to the chosen color of the dye added to the wax 24. The color or colors are used to enhance the aesthetic quality of the popped popcorn 20. In one embodiment, the colors are tailored to a particular holiday (e.g., red and green coated popped popcorn for Christmas, pastel colors for Easter, etc.), a particular season (e.g., white and light blue for Winter, bright colors for Spring, etc.). Likewise, the color or colors are otherwise chosen to coordinate and/or correspond to a specific occasion. In lieu of adding a coloring agent to the coating substance, in one embodiment coloring is sprayed on the coated popped popcorn 20 after it has been made.

To further enhance the decorative aspect of the coated popped popcorn 20, glitter 26 or other like decorative substance is incorporated into the coating material 24. The glitter 26 is generally variously colored and includes, for example, metallic, neon, and iridescent varieties. Similar to above with the coloring agent, in lieu of adding the glitter 26 to the coating substance, in one embodiment glitter 26 is sprinkled on the coated popped popcorn 20 after it has been made. After the glitter 26 has been sprinkled on the coated popped popcorn 20, an additional coat of the coating material 24 is recommended to ensure that the glitter stays in place.

In one embodiment, the coating material includes a scent-producing or olfactory substance. For example, to make the coated popped popcorn 20 emit a smell reminiscent of Christmas, the scent of peppermint, cinnamon, pine, and the like is added to the coating material 24. The scent-producing substance can also be sprayed on the coated popped popcorn 20 after it has been made.

In one embodiment, the coating material 24 is a combination of several of the above-noted substances including, but not limited to, wax, glue, plastic, a preservative, coloring, a scent-producing substance, and the like. As those skilled in the art will appreciate, the substances can be collectively incorporated into the coating material 24. Likewise, the substances can be individually or collectively systematically applied to the coated popped popcorn 20 after that coated popped popcorn has been formed. To keep one or more of the directly applied substances secured to and/or infused into the coated popped popcorn 20, an additional coat of the coating substance 24 (e.g., wax) or other coating material is suggested.

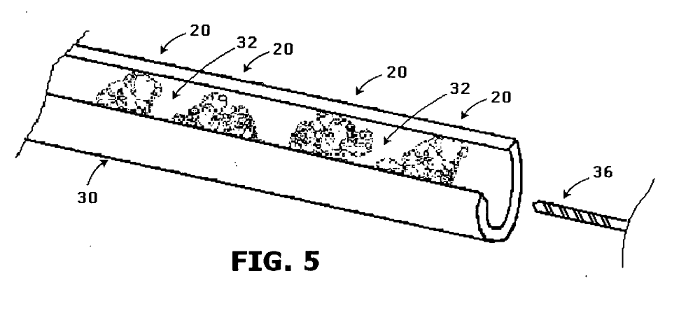

Referring back to FIG. 1, after the coated popped popcorn 20 has been formed, the method 10 includes securing 28 the coated popped popcorn 20. In the illustrated embodiment of FIG. 5, several pieces of the coated popped popcorn 20 are shown clamped within a sleeve 30. The sleeve 30 is generally formed from a piece of foam, a plastic tube, or a length of polyvinyl chloride (PVC) pipe. As shown, the pieces of the coated popped popcorn 20 are inserted in the sleeve 30 adjacent to one another using a lengthwise opening 32. Therefore, the pieces of the coated popped popcorn 20 are securely held or organized in a linear arrangement. When organized this manner, numerous pieces of the coated popped popcorn 30 are suitable for simultaneously operation during the manufacturing process.

In one embodiment, after the pieces of coated popped popcorn 20 are placed in the sleeve 30, opposing edges of the lengthwise opening 32 are drawn together by tightly wrapping tape or other known radial tightening devices around the sleeve. Due to the added strength and durability provided by the coating on the pieces of coated popped popcorn 20, the pieces will not break or crumble when they are clamped inside the sleeve 30 or when the lengthwise opening 32 of the sleeve is contracted to provide further securement.

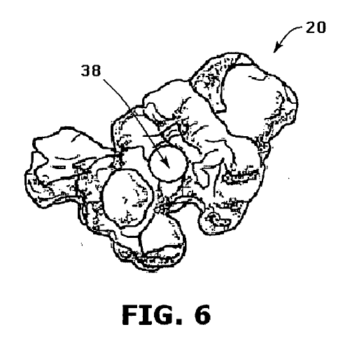

Referring back to FIG. 1, after the coated popped popcorn 20 has been secured within the sleeve 30, the method 10 includes puncturing 34 each of the pieces of coated popped popcorn 20. In one embodiment, the pieces of coated popped popcorn 20 are individually and sequentially pierced by advancing an elongate member 36 through the linearly arranged pieces of coated popped popcorn. As shown in FIG. 5, the elongate member 36 is depicted as a long drill bit. In one embodiment, the elongate member 36 is a rotating or non-rotating wire. After the elongate member 36 has been inserted through and then retracted from each of the pieces of coated popped popcorn 20 held in the sleeve 30, the pieces are extracted from the sleeve. When removed, the pieces of coated popped popcorn 20 reveal an aperture 38 as illustrated in FIG. 6.

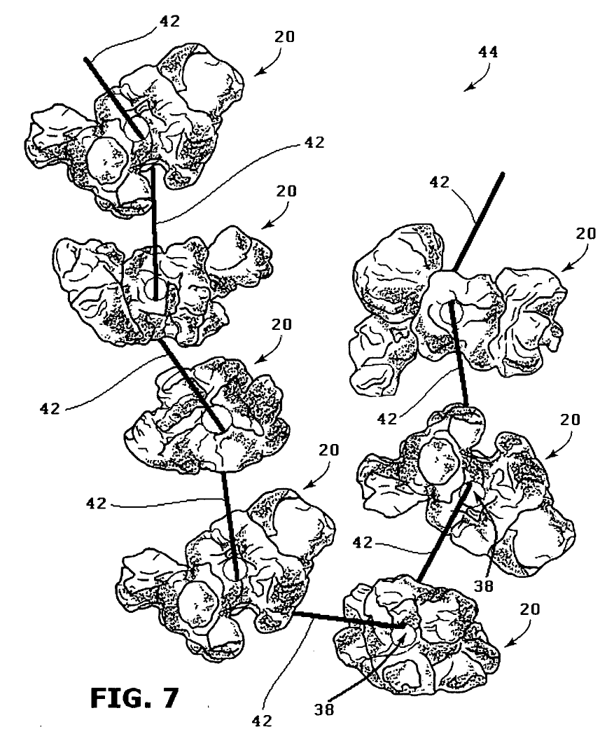

Using the apertures 38, the next step in the method of FIG. 1 includes stringing 40 each of the pieces of the coated popped popcorn 20 together using a string 42 or wire to form a garland 44 as depicted in FIG. 7. In one embodiment, the pieces of the coated popped popcorn 20 are lashed together when the string 42 is fed into each of the apertures 38 by hand. In another embodiment, the elongate member 36 is threaded and draws the string 42 through each of the apertures 38 as they are formed. The process of stringing 40 together the various pieces of the coated popped popcorn 20 is automated to varying degrees depending on the number of garlands 44 to be manufactured. In one embodiment, the entire garland 44 is provided with an additional coat of the coating material 24 to enhance durability or an aesthetic quality.

In one embodiment, to enhance the aesthetic quality of the garland 44, adjacent pieces of the coated popped popcorn 20 are alternately or variously colored, glittered, and plainly coated. Likewise, beads, candy, lights, and other objects are placed on the string 42 along with the pieces of the coated popped popcorn 20 when the garland 44 is formed. The stringing 40 step is continued until each garland 44 is manufactured to one of several convenient lengths (e.g., two feet, ten feet, fifteen feet, etc.).

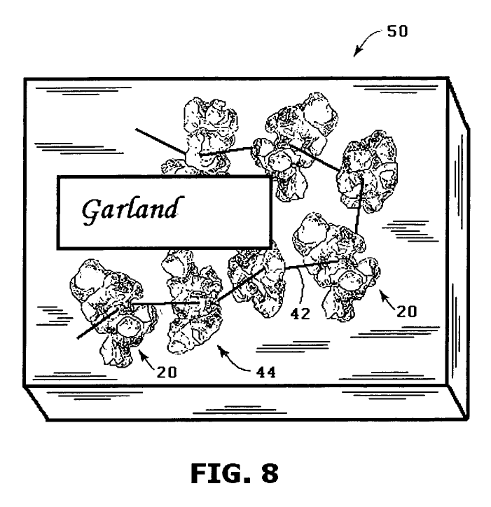

Referring back to FIG. 1, after the garland 44 has been made, the method 10 includes packaging 46 the garland 44 for retail sale as a final step or end 48 to the method. In the illustrated embodiment of FIG. 8, the garland 44 is packaged inside a box-shaped retail package 50. As those skilled in the art will recognize, the packaging 46 step is completed using a variety of different forms of packaging material. For example, in one embodiment the garland 44 is hung from a cardboard or plastic placard having an eyelet. In such a case, the garland 44 is slid upon and suspended from a conventional retail display hook for display to a potential consumer in a retail setting. The garland 44 can also be packaged by simply wiring the garland together with ribbon, plastic ties, string, or the like, and then hanging the garland from the same.

In one embodiment, the retail package 50 is formed to resemble a Christmas tree, a candy cane, Santa Claus, a reindeer, a sleigh, an elf, an ornament, a snowflake, a bag of presents, and other objects associated with a holiday or occasion. The retail package 50 is, at times, made from a transparent or translucent material so that the garland 44 contained therein is easily viewed by a consumer. In one embodiment, the retail package 50 also includes artwork, decorations, a label, and the like.

In an alternative embodiment of the method of FIG. 1, instead of puncturing 34 the coated popped popcorn 20, the string 42 is simply pressed down into the coated popped popcorn. This step is performed either while the coated popped popcorn 20 is held with the sleeve 30 or after it has been extracted therefrom. The coated popped popcorn 20 is able to withstand stringing in this fashion due to the increased strength and durability provided by the coating substance 24. After the string 42 is pressed into the coated popped popcorn 20, an additional coating is formed on each piece of the previously coated popped popcorn 20. This ensures that the string 42 is well secured to each of the pieces of the previously coated popped popcorn 20 and that garland 44 is sturdy.

In one embodiment, the pre-drilled coated popped popcorn 20 shown in FIG. 6 is placed in the retail package 50 along with a length of the string 42 or wire. Thereafter, the garland 44 is offered for sale in an unassembled state. After purchase, consumers are able to construct the garland 44 themselves. In this embodiment, the consumer is still able to enjoy the experience of making the garland 44 without having to endure many of the drawbacks associated with the traditional garland making process.

From the foregoing, those skilled in the art will recognize that the method 10 of FIG. 1 is employable to form a more durable garland 44. Due to added strength of the coated popped popcorn 20, the longevity of the garland 44 is increased relative to traditional garlands. As such, the garland 44 is available for use as a decoration for several years. Moreover, because each of the pieces of the coated popped popcorn 20 are either colored, glittered, and scented as well as employed with beads, candy, lights, and the like, the garland 44 is much more visually and aromatically pleasing to a consumer.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of making a garland suitable for retail sale using popped popcorn, the method comprising the steps of:
coating the popped popcorn;
stringing the coated popped popcorn together to form the garland; and
packaging the garland for retail sale such that the garland is suitable for retail sale.

2. The method of claim 1, wherein the popped popcorn is coated with wax.

3. The method of claim 2, wherein the wax includes at least one of dye, glitter, and a scented substance.

4. The method of claim 1, wherein the method further comprises the step of sprinkling glitter onto the coated popped popcorn.

5. The method of claim 1, wherein the method further comprises the step of coating the popped popcorn with at least one of a confectionary substance and a sugar.

6. The method of claim 1, wherein the popped popcorn is coated with at least one of plastic and glue.

7. The method of claim 1, wherein the method further comprises the step of providing a scent to the coated popped popcorn.

8. The method of claim 1, wherein the method further comprises the step of linearly arranging the popped popcorn to facilitate the forming and stringing steps.

9. The method of claim 1, wherein the method further comprises the step of stringing at least one of beads, candy, and lights on the garland adjacent to the coated popped popcorn.

10. The method of claim 1, wherein the stringing step is performed by forming an aperture through each piece of the coated popped popcorn.

11. The method of claim 1, wherein the stringing step is performed by pressing a string through each piece of the coated popped popcorn and then coating each piece of the popped popcorn again.

12. A method of making a garland suitable for retail sale using popped popcorn, the method comprising the steps of:
coating the popped popcorn;
holding the coated popped popcorn in a linear arrangement;
forming an aperture through each piece of the coated popped popcorn held in the linear arrangement;
stringing each piece of the coated popped popcorn together using the apertures to form the garland; and
placing the strung, coated popped popcorn at least one of in and on a retail package for sale.

13. The method of claim 12, wherein each piece of the popped popcorn is coated with a substance selected from the group consisting of wax, glitter, colored dye, an olfactory substance, glue, plastic, and combinations thereof.

14. The method of claim 12, wherein the popped popcorn is produced from yellow popcorn.

15. The method of claim 12, wherein the method further comprises the step of coating the coated popped popcorn again.

16. The method of claim 12, wherein the method comprises forming the retail package to resemble a one of a Christmas tree, a candy cane, Santa Claus, a reindeer, a sleigh, an elf, an ornament, a snowflake, and a bag of presents.

17. A garland comprising:
pieces of wax-coated popped popcorn, each of the pieces of wax-coated popped popcorn including an aperture; and
a string passing through the aperture in each of the pieces of the wax-coated popped popcorn.

18. The garland of claim 17, wherein one or more of the pieces of the wax-coated popped popcorn are dressed with glitter.

19. The garland of claim 17, wherein one or more of the pieces of wax-coated popped popcorn include a scented substance.

20. The garland of claim 17, wherein the garland is placed at least one of in or on a retail package for retail sale.
